(19) United States
(12) Patent Application Publication
(10) Pub. No.: US 2004/0134852 A1
(43) Pub. Date: Jul. 15, 2004

(54) Hydrocyclone

(76) Inventor: Hans-Peter Kampfer, Herborn (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/645,339

(22) Filed: Aug. 21, 2003

(30) Foreign Application Priority Data
Aug. 24, 2002 (DE) 10239358.3

(51) Int. Cl. B01D 17/038

(52) U.S. Cl. 210/512.1; 210/541

(57) ABSTRACT

A hydrocyclone for separating solid particles from a particle-carrying fluid has according to the invention a housing defining a chamber, a port opening into the chamber for admitting the particle-carrying fluid into the chamber for forming therein a vortex flow of the fluid, and a tube connected axially to the housing and forming an outlet therefor. The tube has an inner surface composed of a hard material consisting essentially of tungsten-carbide particles in a metallic binder having by weight a nickel content of at most 12% and a chromium content equal to at most 15% of the nickel content. The chromium content is equal to between 0.5% and 10% of the nickel content, preferably the binder has a nickel content of about 8.5% and a chromium content of about 1.3%.

### FIELD OF THE INVENTION

The present invention relates to a cyclone-type centrifugal hydrocyclone. More particularly this invention concerns a hydrocyclone.

### BACKGROUND OF THE INVENTION

A hydrocyclone has a vortex chamber into which a fluid carrying entrained solids is pumped, normally tangentially, so as to generate a cyclonic or vortex flow from which the solids are separated because of their greater momentum, while the fluid is withdrawn axially through an outlet tube. Such a device can be used for many separating tasks, for example separating oil from an oil/sand/water mixture as is recovered by an offshore drilling rig.

In the vortex chamber itself and the outlet tube, significant wear can occur, especially when the solids are abrasive materials. This wear gives rise to rapid deterioration of the cyclone so within a relatively short operating time the vortex chamber, other parts of the cyclone, or the entire cyclone must be replaced. The apparatus in which the cyclone is incorporated then must be taken out of service for a considerable time to allow replacement and significant costs are then engendered by the need to replace the cyclone or the parts thereof.

There are cyclones in which the parts for those portions subjected to the greatest wear are replaceable. Such cyclones need not be replaced entirely since only the parts which become worn need then be removed and replaced by new or reconstructed parts. While this amounts to some saving in cost, it nevertheless requires the cyclone and the apparatus in which it is incorporated to be brought down for considerable periods of time and the costs caused by bringing down the cyclone are not materially reduced.

There are also cyclones which have at their wear-sensitive areas parts formed from wear-resistant materials. These cyclones have longer lives and the frequency of standstill periods is somewhat reduced. However, since the parts involved are nevertheless subject to significant wear, it is still a requirement that those parts be replaced and those parts of the cyclone which are not constructed of the wear-resistant materials be also replaced from time to time. The downtime costs, even for such less frequent periods, remains substantial.

### OBJECTS OF THE INVENTION

It is therefore an object of the present invention to provide an improved hydrocyclone.

Another object is the provision of such an improved hydrocyclone which overcomes the above-given disadvantages, that is very wear resistant and that can be refitted and/or repaired easily.

### SUMMARY OF THE INVENTION

A hydrocyclone for separating solid particles from a particle-carrying fluid has according to the invention a housing defining a chamber, a port opening into the chamber for admitting the particle-carrying fluid into the chamber for forming therein a vortex flow of the fluid, and a tube connected axially to the housing and forming an outlet therefor. The tube has an inner is surface composed of a hard material consisting essentially of tungsten-carbide particles in a metallic binder having by weight a nickel content of at most 12% and a chromium content equal to at most 35% of the nickel content.

Such a cyclone has an exceptionally long service life. The lining according to the invention for the vortex chamber and output tube wear so little that it need only be replaced after much more use than any prior-art system.

According to the invention the chromium content is equal to between 0.5% and 10% of the nickel content, preferably the binder has a nickel content of about 8.5% and a chromium content of about 1.3%. Such a composition has shown itself to be extremely advantageous.

The hard material in accordance with the invention also consists of other carbides selected from the group comprised of titanium carbide, niobium carbide, tantalum carbide, chromium carbide, and molybdenum carbide. These carbides are quite similar to tungsten carbide and are used in accordance with the particular application to which the hydrocyclone is set.

The hydrocyclone according to the invention can have particles of an average particle size of between 0.1 μm and 2.5 μm, of a density between 14.4 g/cm³ and 15.2 g/cm³, and of a hardness of at least 1700 HV10.

In yet another embodiment of the invention that has proven particularly wear resistant, the particles have an average particle size of between 0.15 μm and 0.5 μm, a density between 14.0 g/cm³ and 15.0 g/cm³, and a hardness between 1700 HV10 and 1800 HV10. Such an average particle side, density, and hardness produce exceptional wear resistance for the wear-prone lining of the hydrocyclone.

Another improvement in wear resistance is achieved when the particles have a density of about 14.55 g/cm³ and/or a hardness of about 1760 HV10. Preferably the particles are a powder-metallurgically produced sintered hard material.

### BRIEF DESCRIPTION OF THE DRAWING

The above and other objects, features, and advantages will become more readily apparent from the following description, reference being made to the accompanying drawing in which:

FIG. 1 is a longitudinal section through a cyclone for the separation of solids from fluids utilizing centrifugal force;

FIG. 2 is a view similar to FIG. 1 of another cyclone;

FIG. 3 is a front view of the vortex chamber of the cyclone shown in FIG. 1;

FIG. 4 is a side view of the vortex chamber of FIG. 3;

FIG. 5 is a front view of the vortex chamber of the cyclone of FIG. 2; and

FIG. 6 is a side view of the vortex chamber shown in FIG. 5.

### SPECIFIC DESCRIPTION

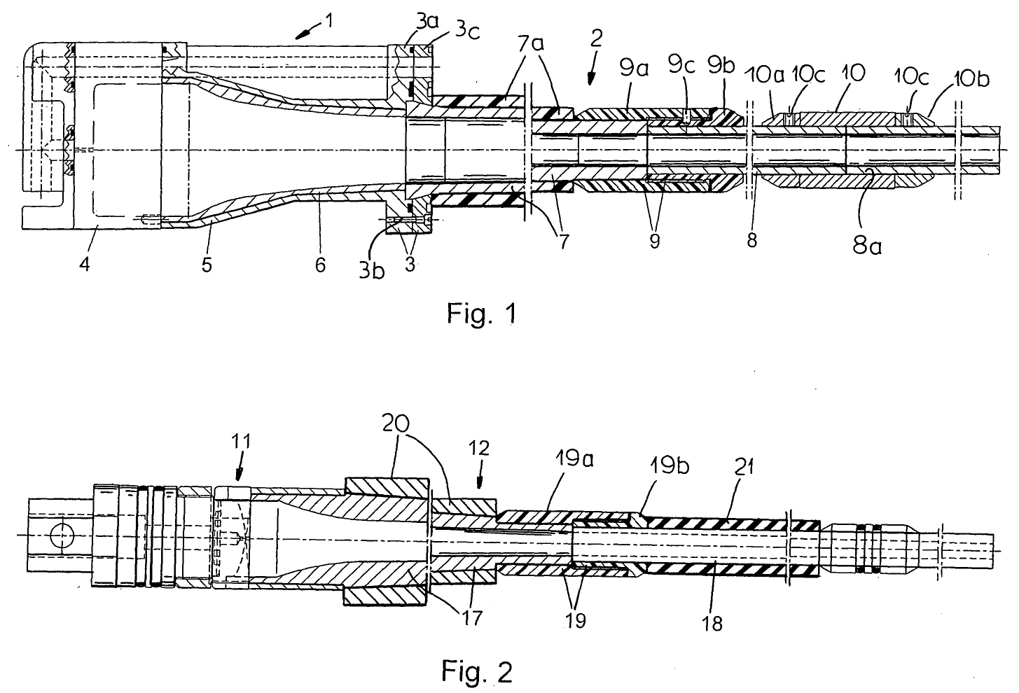

The cyclone shown in FIG. 1 comprises a housing 1 forming a vortex chamber and an outlet tube 2 which are connected together by elements 3. In particular, the connecting element 3 in this embodiment can include a flange 3a on an outer flared part 5 of the vortex chamber 1 which can be composed of steel and is shrunk onto a funnel-shaped insert or liner 6 composed of the metallic hard material described above.

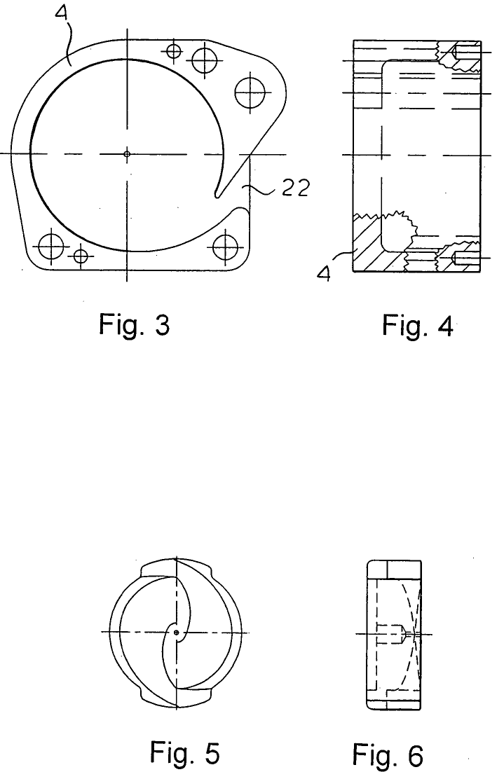

The conical part 5 communicates with a cylindrical part 4 which has the configuration shown in FIG. 3, including a tangential inlet port 22 through which a solids/fluid mixture being separated according to this invention is pumped and which is formed of the hard material according to the invention. The flange 3a is connected by bolts 3b with a ring 3c which attaches a first part 7 of the outlet tube 2 to the cyclone forming part 5 and lining 6 and is composed entirely of the hard material mentioned previously. The part 7 can be surrounded by a plastic or rubber reinforcement 7a and can be joined to a second part 8 of the outlet tube 2 also completely formed from the hard material by a connecting element 9. In this embodiment, the connecting element 9 is comprised of two plastic sleeves 9a and 9b adhesively bonded to the parts 7 and 8 and interconnected by a set screw 9c. A steel sleeve 10 may be shrunk onto the parts 8 and 8a of the outlet tube 2 and can be located between steel rings 10a and 10b held in place by set screws 10c.

In the embodiment of FIG. 2, the vortex-chamber housing 11 constituting and the outlet tube 12 are composed of tubes 17 and 18 connected together by a connecting element 19 formed from two plastic sleeves 19a and 19b as described for the connecting element 9. Aluminum or other light metal outer sleeves 20 can be provided on the parts 17 and 18 composed of the hard material or a rubber sleeve 21 may be drawn over the parts. As will be apparent from FIGS. 3 and 4 as well as from FIGS. 5 and 6, the vortex chambers can have a variety of configurations.

I claim:

1. A hydrocyclone for separating solid particles from
a particle-carrying fluid, the hydrocyclone comprising:
a housing having an inner surface defining a chamber;
means including a port opening into the chamber for admitting the particle-carrying fluid into the chamber for forming therein a vortex flow of the fluid; and
a tube connected axially to the housing, forming an outlet therefor and having an inner surface, the inner surfaces of the tube and housing being composed of a hard material consisting essentially of tungsten-carbide particles in a metallic binder having a nickel content of at most 12% and a chromium content equal to at most 15% of the nickel content.

2. The hydrocyclone defined in claim 1 wherein the chromium content is equal to between 0.5% and 10% of the nickel content.

3. The hydrocyclone defined in claim 1 wherein the metallic binder has a nickel content of about 8.5% and a chromium content of about 1.3%.

4. The hydrocyclone defined in claim 1 wherein the hard material also consists of other carbides selected from the group comprised of titanium carbide, niobium carbide, tantalum carbide, chromium carbide, and molybdenum carbide.

5. The hydrocyclone defined in claim 1 wherein the particles have an average particle size of between 0.1 μm and 2.5 μm.

6. The hydrocyclone defined in claim 1 wherein the particles have a density between 14.4 g/cm³ and 15.2 g/cm³.

7. The hydrocyclone defined in claim 1 wherein the particles have a hardness of at least 1700 HV10.

8. The hydrocyclone defined in claim 1 wherein the particles have
an average particle size of between 0.15 μm and 0.5 μm;
a density between 14.0 g/cm³ and 15.0 g/cm³; and
a hardness between 1700 HV10 and 1800 HW10.

9. The hydrocyclone defined in claim 8 wherein the particles have a density of about 14.55 g/cm³.

10. The hydrocyclone defined in claim 8 wherein the particles have a hardness of about 1760 HV10.

11. The hydrocyclone defined in claim 10 wherein the particles are a powder-metallurgically produced sintered hard material.
